(19) United States
(12) Patent Application Publication
(10) Pub. No.: US 2011/0165433 A1
(43) Pub. Date: Jul. 7, 2011

(54) Erosion and corrosion resistant coating system for compressor

(75) Inventors: Surinder S. Pabla, Greer, SC (US); Krishnamurthy Anand, Bangalore (IN); Paul S. Dimascio, Greer, SC (US); Stuart S. Collins, Simpsonville, SC (US); James A. Ruud, Delmar, NY (US); Suchismita Sanyal, Bangalore (IN)

(73) Assignee: General Electric Company, Schenectady, NY (US)

(21) Appl. No.: 12/654,843

(22) Filed: Jan. 6, 2010

(51) Int. Cl. B32B 15/04; B05D 1/36; C09D 1/00

(52) U.S. Cl. 428/615; 427/405; 106/1.05

(57) ABSTRACT

Process for providing a protective coating to a metal surface by applying a nickel or tantalum plate layer to the surface and dispersing particles of a hard material such as diamond, alumina, vanadium nitride, tantalum carbide and/or tungsten carbide within the nickel or tantalum plate layer as the plating is occurring.

The present invention relates to a coating system for providing metal surfaces with improved water droplet erosion protection, enhanced corrosion pitting resistance, enhanced crevice corrosion resistance, improved surface finish and improved antifouling capability. More particularly, the invention provides a metal article, for example a turbine compressor blade or an airfoil for rotating blade applications, having a surface susceptible to erosion, corrosion and pitting, which has applied thereto a Ni-containing or tantalum-containing coating in which hard particles, such as diamond particles, alumina particles, vanadium nitride, tantalum carbide and/or tungsten carbide particles, are dispersed in the nickel or tantalum layer. The invention also relates to a process for providing a protective coating to a metal surface by applying a nickel or tantalum plate layer to the surface and dispersing the particles of hard material such as diamond, alumina, vanadium nitride, tantalum carbide and/or tungsten carbide within the nickel or tantalum plate layer.

### BACKGROUND OF THE INVENTION

It is known that stainless steel compressor blades employed in gas turbines undergo water droplet erosion and corrosion pitting induced cracking, since modern gas turbines employ on-line water wash, fogging and/or evaporation cooler systems to enhance compressor efficiency. In addition, turbine units are often deployed in environments which are highly corrosive, for example in close proximity to chemical petroleum plants or at the ocean coastline.

One approach to solving this problem would be to change the material used to fabricate the blades. While this may result in improvement of corrosion resistance, it is unclear whether it would solve the water droplet erosion problem.

Another approach might be to use alternate alloys for compressor blades, but this is typically not cost effective. Redesign of the blade to achieve better overall robustness may likewise not be feasible since these alloys are sensitive to rub and fretting.

A need exists for a turbine blade coating system that is capable of protecting blades susceptible to water droplet erosion and corrosion damage. The present invention seeks to satisfy that need.

### BRIEF DESCRIPTION OF THE INVENTION

It has now been discovered, according to the present invention, that it is possible to provide improvement in both water droplet erosion and corrosion resistance of metal surfaces, for example in compressor blades and airfoils for rotating blade applications. Thus, in one aspect, there is provided a coating system comprising a Ni-containing or tantalum-containing composition having hard particles, such as diamond particles, alumina particles, vanadium nitride, tantalum carbide and/or tungsten carbide particles, dispersed throughout the nickel-containing or tantalum-containing composition.

In another aspect, the invention provides a process for providing a protective coating to a metal surface by applying a nickel or tantalum plate layer to the surface and dispersing the particles of hard material such as diamond, alumina, vanadium nitride, tantalum carbide and/or tungsten carbide within the nickel or tantalum plate layer. The dispersion of the particles is typically carried out as the plating is occurring.

In a further aspect, there is provided a metal component coated with a coating composition of the invention using the process of the invention.

The metal surface coated according to the present process exhibits enhanced blade anti-fouling capability and improved damage tolerance. Other advantages are excellent resistance of the coated surface to water impingement erosion and corrosion resistance of the coated surface.

### BRIEF DESCRIPTION OF THE DRAWINGS

FIG. 1 is a schematic cross-section showing the nickel plate layer with hard particles dispersed therein and a water droplet located on an upper surface thereof;

FIG. 2 is a schematic cross-section showing the role of hard particles in the present invention;

FIG. 3 shows a turbine blade having a Ni plated coating with diamond particles impregnated in the nickel plated coating.

### DETAILED DESCRIPTION OF THE INVENTION

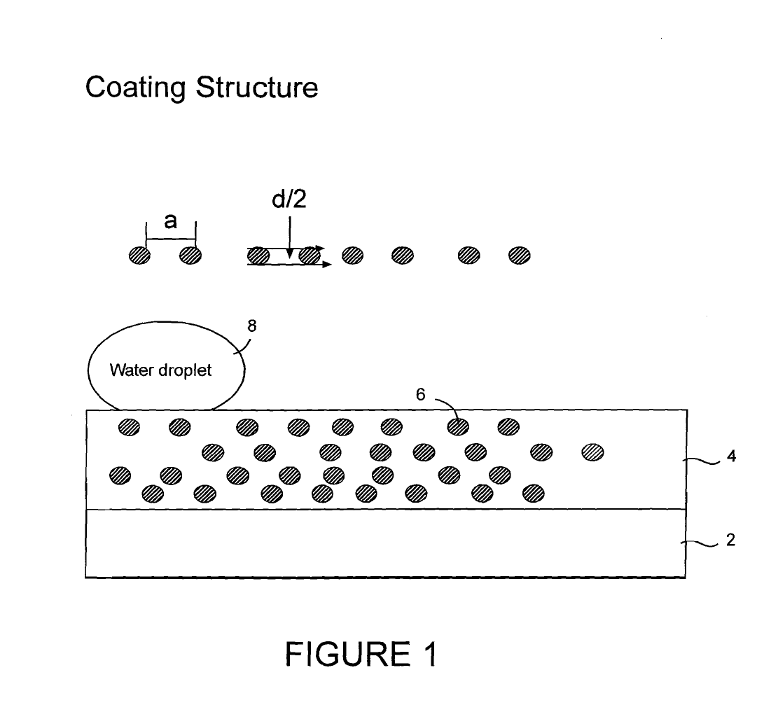

Referring to FIG. 1, there is shown schematically a cross-section of a metal substrate 2 having a nickel plate layer 4 with hard particles 6 dispersed therein. A water droplet 8 is shown located on an upper surface of the layer 4.

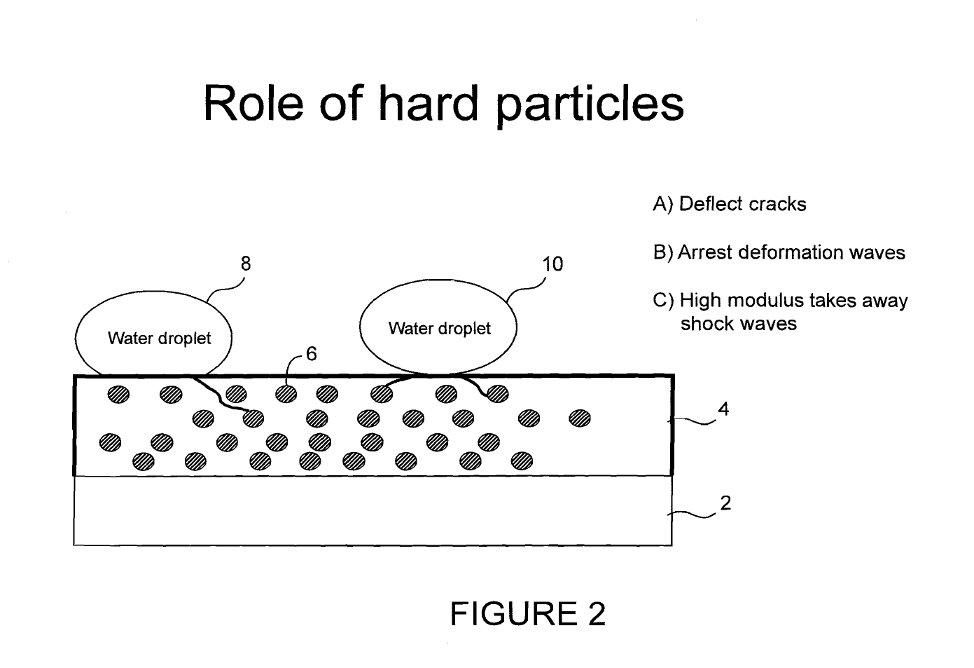

FIG. 2 shows schematically a cross-section of the metal substrate 2 having the nickel plate layer 4 with hard particles 6 dispersed therein, and two water droplets 8 and 10 located on the upper surface of the layer 4. In this Figure, it will be seen that the hard particles assist in deflecting cracks, arresting deformation waves and dissipating shock waves.

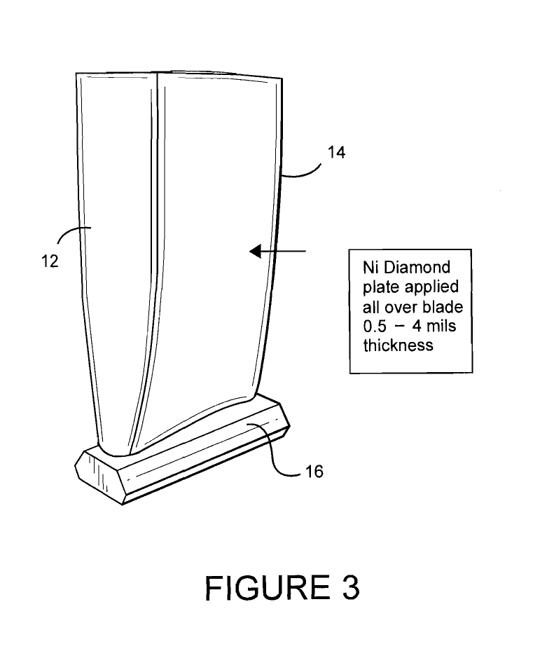

FIG. 3 shows a turbine blade 12 having a Ni plated coating 14 with diamond particles impregnated in the nickel plated coating, typically to a thickness of 0.5 to 1 mil. The base 16 of the blade is usually uncoated.

The present invention thus provides an improvement in both water droplet erosion and corrosion resistance of metal surfaces, for example in compressor blades and airfoils for rotating blade applications, by way of a coating system comprising a Ni-containing or Ta-containing composition having hard particles, such as diamond particles, alumina particles, vanadium nitride, tantalum carbide and/or tungsten carbide particles, dispersed throughout the Ni- or Ta-containing composition.

In another aspect, the present invention provides a process for applying a protective coating to a metal surface susceptible to corrosion and pitting. This is achieved by a nickel/hard particle or tantalum/hard particle composite layer applied to the surface, with the particles of a hard material dispersed within the nickel or tantalum plate layer. Typically, the hard particles are dispersed within the coating layer as the layer is applied to the metal surface.

In another aspect, the metal surface is provided with an erosion resistant hydrophobic surface which will enable water droplets to impact and fragment to smaller droplets with lower propensity to cause erosion damage. The hydrophobic surface should contain hard particles or a hard coating which is both chemically hydrophobic and, if required, textured to maintain contact angles that further augment the hydrophobic nature of the surface. Examples of such compositions include vanadium nitride embedded in nickel matrix, tin ion nickel matrix (microstructure similar to other embodiments). Coatings such as this can be deposited by techniques such as thermal spray, PVD, and composite plating.

In a further embodiment, the nickel/hard particle composite plating or tantalum/hard particle composite plating can be provided with a hydrophobic thin film coating so that the water droplets are unable to wet the surface. The effect of the hydrophobic coating is that the water droplets rather than wetting the surface instead implode releasing the shock wave.

The absence of film formation can be aided either by the composition of the overlay (such as VN, TiN, CrN), or by texture. The hydrophobic materials can be applied either as a stand-alone overlay or can be embedded in a tough hydrophobic metallic binder such as nickel.

With regard to texture, it is possible to have posts of particles surrounded by a matrix that is in a recess, so that the contacting water droplet does not get enough surface to hold on to. Alternatively, the coating can have pores designed in so that the droplets see partly a surface and partly a hole and they cannot adhere to the hole.

The hard particles can be held by a corrosion resistant binder, which can be typically nickel. Under extremely corrosive conditions, other metallic matrix materials such as tantalum can be used to offer a step change in corrosion resistance. The hard particles discussed above also serve to impart wear resistance and hydrophobicity to the surface.

Typically the hard material is selected from diamond, alumina, vanadium nitride, titanium carbide, titanium nitride, tantalum carbide and tungsten carbide. Mixtures of these hard materials may also be employed. Such mixtures can vary from 100-0 percent depending on cost and life required. Diamond is the hardest but also the most expensive. When diamond is employed, it may be mixed, for example 50:50 by weight, with alumina to provide a somewhat lower performance but at reduced cost.

Other hard materials, for example SiC, silicon nitride, cBN, TiC, TiN, may also be employed if desired. A particular benefit of TiN is that it is hydrophobic.

The hard material is usually in the form particles having size range of from 0.1 to 15 microns. For diamond and alumina, the particle size range is typically 0.1 micron to 8 microns. For tungsten carbide, the particle size range is usually 0.1 micron to 10 microns, for example 0.1 micron to 8 microns.

The spacing between particles is typically 0.1 to 150 microns. For TiN, the spacing is usually 0.1 to 100 microns. This range can be determined by particle sizes.

The concentration of the hard material in the nickel layer is typically in the range of 10-70% loading. Loading in the context of the present application refers to the volume fraction of particles to matrix. Thus, a volume fraction of 30% would have a lower erosion resistance due to a lower percentage of hard particle phase.

The coating process of the invention is typically carried out utilizing a plating technique, with particles entrapped, entrapped plating electroless or electroplating. In electroplating, the part is made cathodic with nickel ions supplied from a nickel rich anode in a nickel salt solution. Electroless nickel plating is an auto-catalytic reaction used to deposit a coating of nickel on a substrate. Unlike electroplating, it is not necessary to pass an electric current through the solution to form a deposit. Such techniques are more suited to be used to manufacture composite coatings by suspending powder in the bath.

Electroless nickel plating has several advantages over electroplating. Free from flux-density and power supply issues, it provides an even deposit regardless of work-piece geometry and, with the proper pre-plate catalyst, can deposit on non-conductive surfaces. Other composite compositions such as nickel vanadium nitride and nickel titanium nitride can also be deposited by thermal spraying processes such as suspension plasma, HVOF and HVAF.

Compositions such as tantalum reinforced with diamond, alumina, vanadium nitride can be deposited by a vapor deposition processes. Typically such processes include physical vapor deposition, chemical vapor deposition and plasma enhanced chemical vapor deposition.

An unexpected advantage of the present invention is the excellent water impingement erosion and corrosion resistance of the nickel/diamond plate.

In a yet further embodiment, the matrix is made extremely corrosion resistant by use of a noble metal, and the wear properties are enhanced by addition of hard particles. These would include hard particles such as diamond, SiC, tin, WC. The matrix is preferably selected from Ta and Ta alloyed with tungsten.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A process for providing a protective coating to a surface of a metal component, comprising applying a metal plate layer to the surface and dispersing particles of a hard material within the metal plate layer as the plating is occurring, wherein the metal is selected from nickel and tantalum.

2. A process according to claim 1 wherein said hard material is selected from diamond, alumina, vanadium nitride, tantalum carbide, tungsten carbide, silicon carbide, silicon nitride, cBN, titanium carbide and titanium nitride.

3. A process according to claim 2, wherein said hard material is in the form of particles with a size range of 0.1 to 15 microns.

4. A process according to claim 1, wherein said hard material is diamond.

5. A process according to claim 1, wherein said hard material is alumina.

6. A process according to claim 1, wherein said hard material is tungsten carbide.

7. A process according to claim 1, wherein said hard material is vanadium nitride.

8. A process according to claim 1, wherein an erosion resistant hydrophobic surface is provided on said protective coating.

9. A process according to claim 8, wherein said hydrophobic surface comprises vanadium nitride particles embedded in a nickel matrix.

10. A process according to claim 1, wherein the spacing between said hard particles is 0.1 to 150 microns.

11. A process according to claim 1, wherein the hard material is present in the metal layer in the range of 10-70% by weight.

12. A process according to claim 1, wherein said metal component is a turbine compressor blade.

13. A process according to claim 1, wherein said metal component is an airfoil for a rotating blade application.

14. A process according to claim 1, wherein the concentration of the hard material in the nickel layer is in the range of 10-60% by weight.

15. A process according to claim 1, wherein said protective coating provides improved water droplet erosion protection, enhanced corrosion pitting resistance, enhanced crevice corrosion resistance, improved surface finish and improved antifouling capability.

16. A metal component coated according to the process of claim 1.

17. A metal-containing coating composition suitable for use on a metal substrate having surfaces which are susceptible to erosion, corrosion and pitting, said coating composition comprising a metal selected from nickel and tantalum and hard particles dispersed in the metal.

18. A metal-containing coating composition according to claim 17, wherein said hard particles are selected from diamond particles, alumina particles, vanadium nitride particles, tantalum carbide particles, silicon carbide particles, silicon nitride particles, cBN particles, titanium carbide particles, titanium nitride particles and tungsten carbide particles.
